(19) United States
(12) Patent Application Publication
(10) Pub. No.: US 2005/0258754 A1
(43) Pub. Date: Nov. 24, 2005

(54) Plasma display panel

(76) Inventors: Jae-Ik Kwon, Suwon-si (KR); Kyoung-Doo Kang, Suwon-si (KR)

Correspondence Address: MCGUIREWOODS, LLP, 1750 TYSONS BLVD, SUITE 1800, MCLEAN, VA, 22102, US

(21) Appl. No.: 11/128,361

(22) Filed: May 13, 2005

(30) Foreign Application Priority Data
May 20, 2004 (KR) 10-2004-0035868

(51) Int. Cl. H01J 17/49

(52) U.S. Cl. 313/586

(57) ABSTRACT

A plasma display panel includes a front substrate, a back substrate facing the front substrate, and a plurality of discharge cells between the front substrate and the back substrate. Pairs of discharge electrodes oppose each other in a discharge cell to make a plasma discharge occur in the discharge cell, dielectric layers cover each pair of discharge electrodes, and a thickness of the dielectric layers covering the pairs of discharge electrodes is not uniform.

### CROSS-REFERENCE TO RELATED APPLICATION

This application claims priority to and the benefit of Korean Patent Application No. 10-2004-0035868, filed on May 20, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP having a structure that may control plasma distribution in discharge cells.

2. Discussion of the Background

Recently, display apparatuses using a PDP have been widely used. Such display apparatuses may be thin and lightweight, and they may have a large screen with high image quality and a wide viewing angle. Additionally, they can be simply manufactured, and their size can be easily increased, as compared to other flat panel displays. Therefore, PDP display apparatuses are being considered as next-generation, large-screen flat display apparatuses.

The PDP may be classified as a direct current (DC) type, an alternating current (AC) type, or a hybrid type depending on applied discharge voltage characteristics, and as an opposed-discharge type or a surface-discharge type depending on discharge cell structures. An AC PDP having a three-electrode surface-discharge structure is a typical configuration.

FIG. 1 shows a conventional AC three-electrode surface-discharge PDP 100.

The PDP 100 includes an upper plate 110 and a lower plate 120. The upper plate 110 may include a front substrate 111, common electrodes 112, which are formed on a lower surface of the front substrate 111, scanning electrodes 113, which form discharge gaps in cooperation with the common electrodes 112, a first dielectric layer 114 covering the common electrodes 112 and the scanning electrodes 113, and a protective layer 115 covering the first dielectric layer 114. The lower plate 120 may include a rear substrate 121, address electrodes s 122, which are disposed on the rear substrate 121 extending in a direction to intersect the common electrodes 112 and the scanning electrodes 113, a second dielectric layer 123 covering the address electrodes 122, partition walls 128, which are formed on an upper surface of the second dielectric layer 123 to be spaced from each other and thereby define discharge cells 125, fluorescent layers 126 formed inside the discharge cells 125, and a discharge gas (not shown), which is filled within the discharge cells 125.

In the conventional three-electrode surface-discharge PDP 100 of FIG. 1, the protective layer 115, the first dielectric layer 114, the scanning and common electrodes 113, 112, and the front substrate 111 may absorb about 40% of the otherwise visible rays that the fluorescent layers 126 emit, thereby decreasing light emission efficiency.

Technology for overcoming this problem is disclosed at pages 401 to 406 in International Meeting on Information Display and Exhibition (IMID), DIGEST 2003. A pair of discharge electrodes may be arranged opposing each other in discharge cells, which may improve an aperture ratio of a front substrate and increase discharge area and discharge efficiency.

However, a parallel pair of discharge electrodes that oppose each other may generate a straight electric field, which may make it difficult to control plasma distribution in the discharge cells. For example, plasma moving along a side surface of the discharge cells 125 during plasma discharging may collide with the partition walls and not be used in the discharge. Further, charged particles following the generated electric field may be ion-sputtered into fluorescent substances formed in the discharge cell, which may cause image burn in.

### SUMMARY OF THE INVENTION

The present invention provides a PDP having a structure that may be capable of controlling plasma distribution in discharge cells.

Additional features of the invention will be set forth in the description which follows, and in part will be apparent from the description, or may be learned by practice of the invention.

The present invention discloses a PDP including a front substrate, a back substrate facing the front substrate, and a plurality of discharge cells between the front substrate and the back substrate. A first discharge electrode and a second discharge electrode oppose each other in a discharge cell to make a plasma discharge occur in the discharge cell, and a first dielectric layer covers the first discharge electrode and a second dielectric layer covers the second discharge electrode. A thickness of the first dielectric layer covering the first discharge electrode is not uniform, and a thickness of the second dielectric layer covering the second discharge electrode is not uniform.

The present invention discloses a PDP including a front substrate, a back substrate facing the front substrate, a plurality of discharge cells between the front substrate and the back substrate, and discharge units opposing each other in a discharge cell and for causing a plasma discharge. A distance between the discharge units is not uniform.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a conventional PDP.

FIG. 2 is an exploded cut away perspective view showing a PDP according to a first exemplary embodiment of the present invention.

FIG. 3 is a cross-sectional view taken along line III-III of FIG. 2.

FIG. 4 is a cross-sectional view taken along line IV-IV of FIG. 3.

FIG. 5 is a diagram showing discharge cells and electrodes of FIG. 2.

FIG. 6 is an exploded cut away perspective view showing a PDP according to a second exemplary embodiment of the present invention.

FIG. 7 is a cross-sectional view taken along line VII-VII of FIG. 6.

FIG. 8 is a cross-sectional view taken along line VIII-VIII of FIG. 7.

FIG. 9 is an exploded cut away perspective view showing a PDP according to a third exemplary embodiment of the present invention.

FIG. 10 is a cross-sectional view taken along line X-X of FIG. 9.

FIG. 11 is a cross-sectional view taken along line XI-XI of FIG. 10.

### DETAILED DESCRIPTION OF THE ILLUSTRATED EMBODIMENTS

The present invention will now be described more fully with reference to the accompanying drawings showing exemplary embodiments of the present invention.

### The First Embodiment

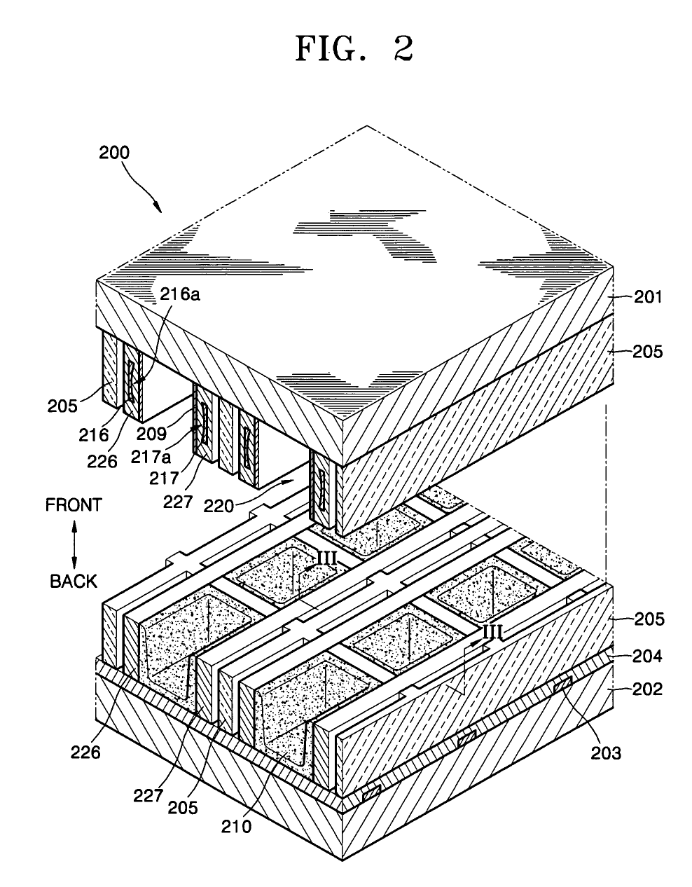

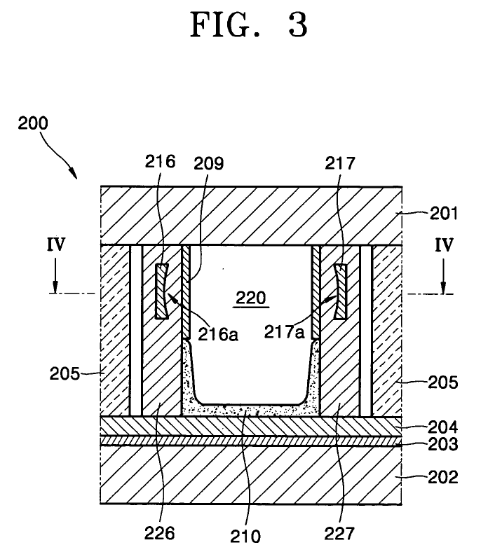

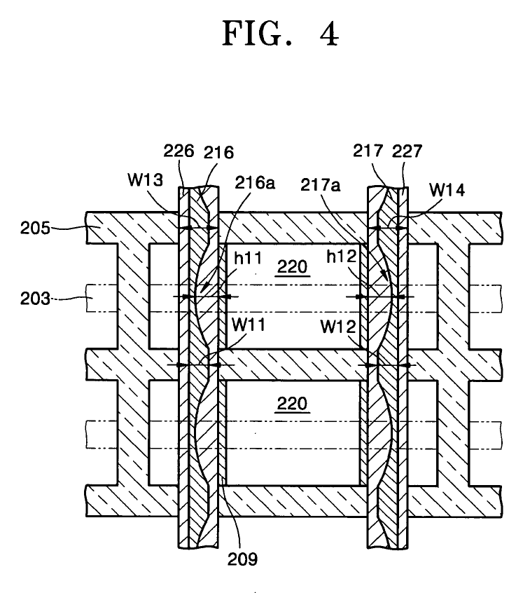

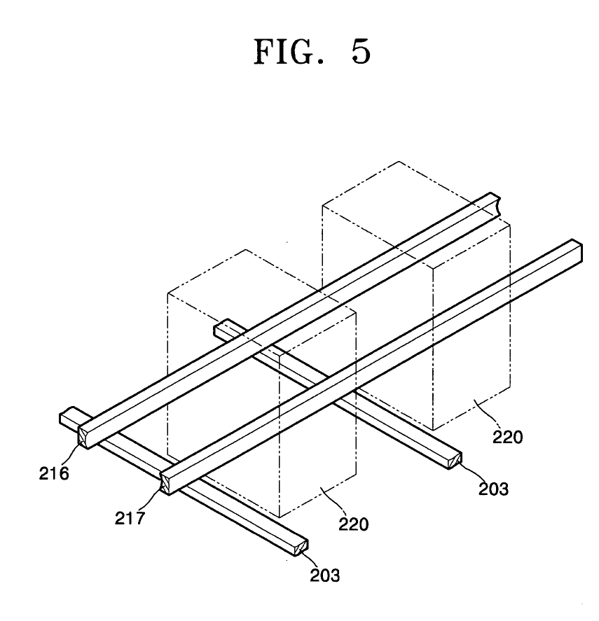

A PDP 200 according to the first exemplary embodiment of the present invention will be described in detail with reference to FIG. 2, FIG. 3, FIG. 4 and FIG. 5.

The PDP 200 may include a front substrate 201, a back substrate 202, partition walls 205, first and second discharge electrodes 216, 217, address electrodes 203, first and second dielectric layers 226, 227, fluorescent layers 210, and a discharge gas (not shown).

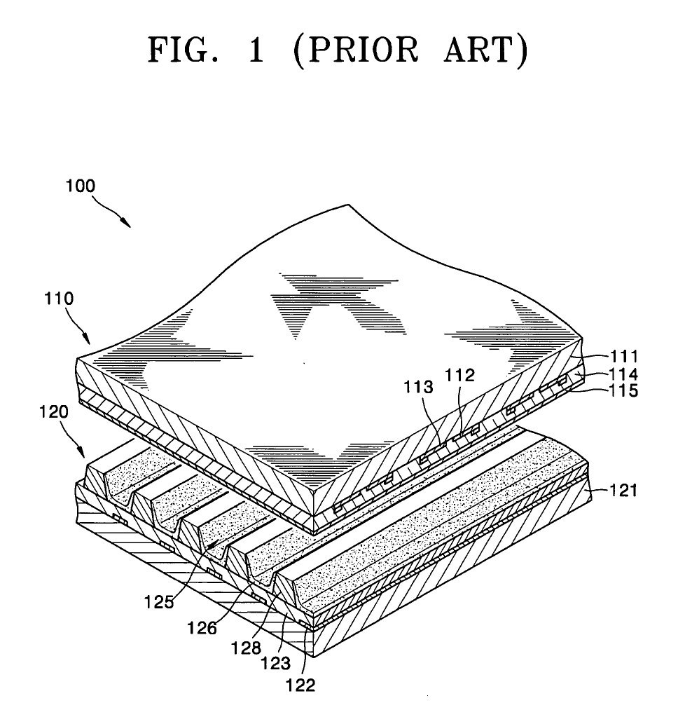

Here, because visible rays generated in discharge cells 220 travel through the front of the PDP 200, the front substrate 201 may be made of material having good light transmittance such as, for example, glass. Unlike the conventional PDP 100 of FIG. 1, discharge electrodes are not formed on the front substrate 201, which may significantly increase front transmittance of visible rays. Therefore, the first and second discharge electrodes 216, 217 may be driven at a relatively lower voltage level in order to display an image at a conventional level of brightness, which improves luminous efficiency.

A plurality of discharge cells 220, in which plasma discharge occurs, are formed between the front substrate 201 and the back substrate 202. Each discharge cell 220 is either a red, green, or blue sub-pixel, and a pixel includes a red, green and blue sub-pixel. Partition walls 205 may be arranged between the discharge cells 220 to prevent electrical and optical cross-talk between adjacent discharge cells 220. However, the partition walls 205 may be omitted.

While FIG. 2 shows the partition walls 205 partitioning the discharge cells 220 in a matrix shape, the partition walls 205 may also partition the discharge cells in various shapes, such as, for example, an open shape such as a stripe, and a closed shape, such as waffle, matrix, delta, and polygonal.

The first and second dielectric layers 226, 227, which extend across opposing sides of the discharge cells 220, are formed in the discharge cells 220. The first and second dielectric layers 226, 227 may be symmetrically arranged in each discharge cell 220. Further, as FIG. 2 and FIG. 3 show, the first and second dielectric layers 226, 227 may have substantially the same height as the partition walls 205.

As FIG. 4 and FIG. 5 show, the first and second discharge electrodes 216, 217, which extend across the discharge cells 220, may be arranged in the first and second dielectric layers 226, 227, respectively, and they extend substantially parallel to the front substrate 201. Further, the first and second discharge electrodes 216, 217 oppose each other in each discharge cell 220, and they may be made of a conductive metal such as, for example, aluminum or copper.

The first and second dielectric layers 226, 227, in which the first and second discharge electrodes 216, 217 are buried, prevent charged particles from colliding with and damaging the first and second discharge electrodes 216, 217 and form wall charges by inducing the charged particles and electrons. The first and second dielectric layers 226, 227 may be made of a dielectric substance such as, for example, PbO, B₂O₃, or SiO₂.

As FIG. 4 shows, in the first exemplary embodiment of the present invention, the thickness h11 of the first dielectric layer 226 covering the first discharge electrode 216 is not uniform. Similarly, the thickness h12 of the second dielectric layer 227 covering the second discharge electrode 217 is not uniform. Specifically, concave portions 216a, 217a may be formed at opposing portions of the first and second discharge electrodes 216, 217, respectively. The concave portions 216a, 217a may be formed by a variety of methods. For example, the concave portions 216a, 217a may be formed by printing electrode paste using a mask that has a concave surface pattern. The concave portions 216a, 217a may be formed in each discharge cell 220, and the widths W11, W12 of the first and second discharge electrodes 216, 217, respectively, vary with the concave portions 216a, 217a. However, the first and second dielectric layers 226, 227 may have substantially uniform widths W13, W14. Therefore, the thicknesses h11, h12 of the first and second dielectric layers 226, 227 are greatest at centers of the concave portions 216a, 217a, and the thicknesses h11, h12 decrease when proceeding away from the centers of the concave portions 216a, 217a and toward the cell's edges.

Applying a discharge voltage between the first and second discharge electrodes 216, 217 may generate an electric field in the discharge cells 220. In this case, the non-uniform thickness of the first and second dielectric layers 226, 227 covering the first and second discharge electrodes 216, 217 controls the plasma distribution in the discharge cells 220. A detailed description thereof will be described later.

In the present embodiment, the first and second discharge electrodes 216, 217 are narrowest at central portions of the discharge cells 220, but the present invention is not limited thereto because various changes in width may enable control of plasma distribution in the discharge cells. For example, the first and second discharge electrodes 216, 217 may be narrowest at edges of the discharge cells 220. In this case, the plasma discharge may intensively occur at edge portions of the discharge cells 220, which may improve luminous efficiency because the fluorescent layers are closer to the edges of the discharge cells 220.

A protective layer 209 may cover side surfaces of the first and second dielectric layers 226, 227 at portions corresponding to the first and second discharge electrodes 216, 217. The protective layer 209, which, for example, may be made of magnesium oxide (MgO), is not required. When included, the protective layer 209 prevents charged particles from colliding with and damaging the first and second dielectric layers 226, 227 and emits secondary electrons during discharging.

The back substrate 202 is arranged substantially parallel to, and a predetermined distance from, the front substrate 201, and it may be made of material principally containing glass.

Further, address electrodes 203 may be formed on the back substrate 202 extending in a direction to intersect the first and second discharge electrodes 216, 217. The address electrodes 203 and the second discharge electrodes 217 generate an address discharge, which facilitates a sustain discharge between the first and second discharge electrodes 216, 217. Specifically, the address electrodes may lower a starting voltage for the sustain discharge. When the address discharge ends, positive ions are stored at the second discharge electrode's side and electrons are stored at the first discharge electrode's side, thereby facilitating the sustain discharge between the second discharge electrode 217 and the first discharge electrode 216.

A dielectric layer 204 covers the address electrodes 203 and prevents charged particles or electrons from colliding with and damaging the address electrodes 203, and it forms wall charges by inducing the charged particles and electrons. The dielectric layer 204 may be made of a dielectric substance such as, for example, PbO, B₂O₃, or SiO₂.

As shown in FIG. 3, fluorescent layers 210 may be coated on the surface of the first and second dielectric layers 226 and 227 that faces inside the discharge cells 220 and on the front surface of the dielectric layer 204.

The fluorescent layers 210 receive ultraviolet rays and emit visible rays. For example, the fluorescent layers formed in red sub-pixels may include a fluorescent substance such as Y(V, P)O₄:Eu, the fluorescent layers formed in green sub-pixels may include a fluorescent substance such as Zn₂SiO₄:Mn or YBO₃:Tb, and the fluorescent layers formed in blue sub-pixels may include a fluorescent substance such as BAM:Eu.

A discharge gas such as, for example, Ne, Xe, or a mixture thereof, is filled and sealed inside the discharge cells 220. According to exemplary embodiments of the present invention, the amount of generated plasma may increase and low-voltage driving may be possible since the discharge area can increase and the discharge space can be enlarged.

In the PDP 200 according to the first exemplary embodiment of the present invention, applying an address voltage between an address electrode 203 and a second discharge electrode 217 generates an address discharge, which selects the corresponding discharge cell 220 to be sustain discharged.

Then, applying a sustain discharge voltage between the first discharge electrode 216 and the second discharge electrode 217 of the selected discharge cell 220 generates a sustain discharge in that cell. During the sustain discharge, plasma and charged particles moving along electric field lines may gather at central portions of the discharge cells 220. Since the discharge occurs mainly at the central portions of the discharge cells 220, loss of plasma from collision with partition walls 205 may decrease.

The sustain discharge excites the discharge gas, which emits ultraviolet rays as its energy level decreases. The ultraviolet rays excite the fluorescent layers 210 coated inside the discharge cells 220, and the fluorescent layers 210 emit visible rays while their energy level decreases, thereby displaying an image.

### The Second Embodiment

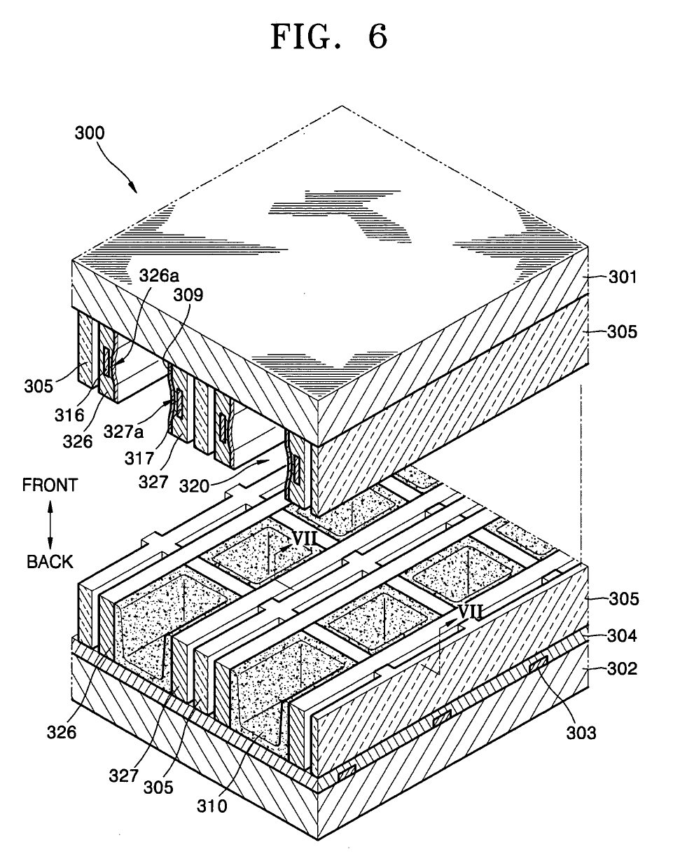

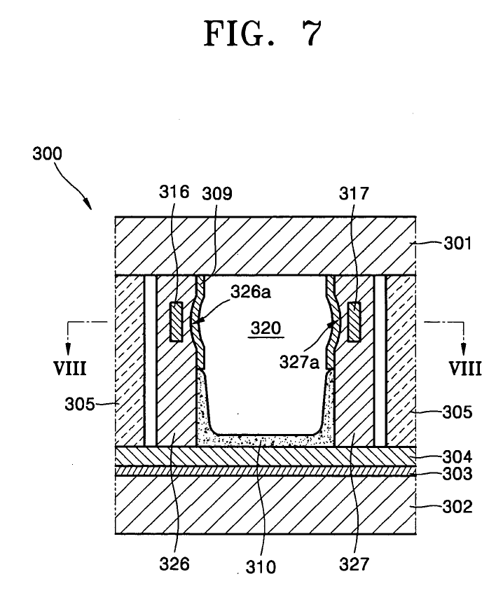

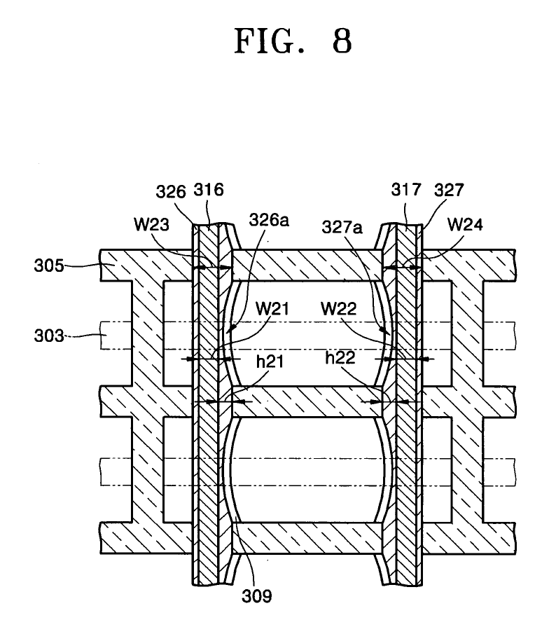

A PDP 300 according to the second exemplary embodiment of the present invention will be described in detail with reference to FIG. 6, FIG. 7 and FIG. 8.

The PDP 300 may include a front substrate 301, a back substrate 302, partition walls 305, first and second discharge electrodes 316, 317, address electrodes 303, first and second dielectric layers 326, 327, fluorescent layers 310, and a discharge gas (not shown). Additionally, the PDP 300 may further include a dielectric layer 304 covering the address electrodes 303, and a protective layer 309 covering portions of the first and second dielectric layers 326, 327 in which the first and second discharge electrodes 316, 317 are buried.

The structure and the function of the front substrate 301, the back substrate 302, the address electrodes 303, the fluorescent layers 310, the dielectric layer 304, the partition walls 305, and the protective layer 309 are similar to those of the first embodiment. Hence, the description thereof is omitted.

Referring to FIG. 8, the thickness h21 of the first dielectric layer 326 covering the first discharge electrode 316 is not uniform. Similarly, the thickness h22 of the second dielectric layer 327 covering the second discharge electrode 317 is not uniform. Specifically, the first and second discharge electrodes 316, 317 each have a substantially uniform width W21, W22. However, the first and second dielectric layers 326, 327 have concave portions 326a, 327a opposing each other, respectively. The concave portions 326a, 327a may be formed by a variety of methods. For example, the concave portions 326a, 327a may be formed by printing dielectric layer paste using a mask that has a concave surface pattern. The concave portions 326a, 327a may be formed in each discharge cell 220, and the widths W23, W24 of the first and second dielectric layers 326, 327, respectively, vary with the concave portions 326a, 327a. Therefore, the first and second dielectric layers 326, 327 covering the first and second discharge electrodes 316, 317 are narrowest at the concave portions 326a, 327a, and the thicknesses h21, h22 increase when proceeding away from the centers of the concave portions 326a, 327a and toward the cell's edges.

Applying a discharge voltage between the first and second discharge electrodes 316, 317 may generate an electric field in the discharge cells 320. In this case, the non-uniform thickness of the first and second dielectric layers 326, 327 covering the first and second discharge electrodes 316, 317 controls the plasma distribution in the discharge cells 320. Specifically, in the second exemplary embodiment, because plasma may be distributed intensively to central portions of the discharge cells 320, the probability that plasma, excited particles, and the like will collide with the partition walls 305 decreases.

In the second embodiment, the first and second dielectric layers 326, 327 are narrowest at central portions of the discharge cells 320, but the present invention is not limited thereto because various changes in width may enable control of plasma distribution in the discharge cells. For example, the first and second dielectric layers 326, 327 may be narrowest at edges of the discharge cells 320. In this case, the plasma discharge may intensively occur at edge portions of the discharge cells 320, which may improve luminous efficiency because the fluorescent layers are closer to edge portions of the discharge cells 320.

The operation and material characteristics of the first and second discharge electrodes 316, 317 and the first and second dielectric layers 326, 327 are similar to those of the first embodiment, thus the description thereof is omitted.

Additionally, the operation of the PDP 300 according to the second embodiment is similar to that of the first embodiment, thus the description thereof is omitted.

### The Third Embodiment

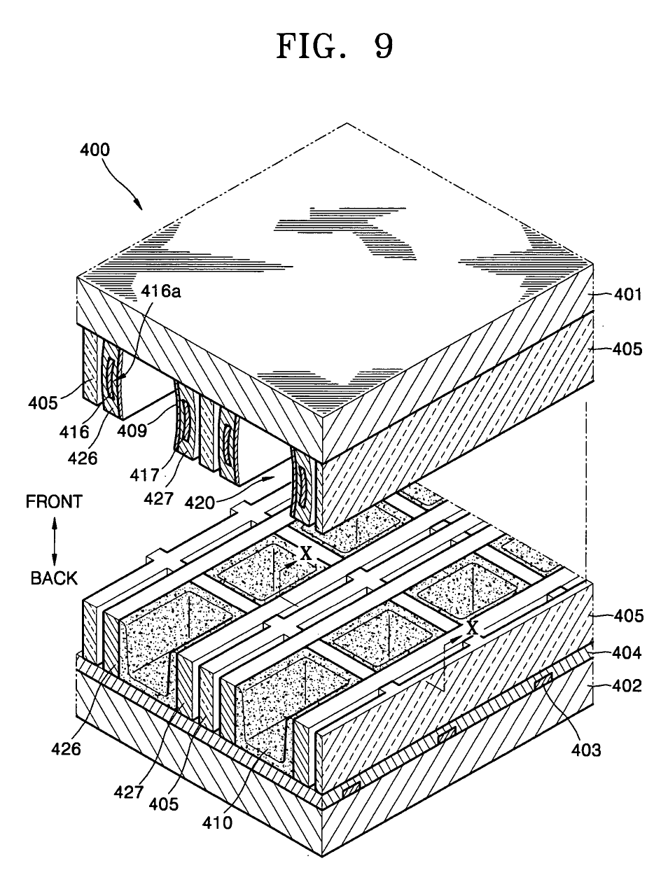

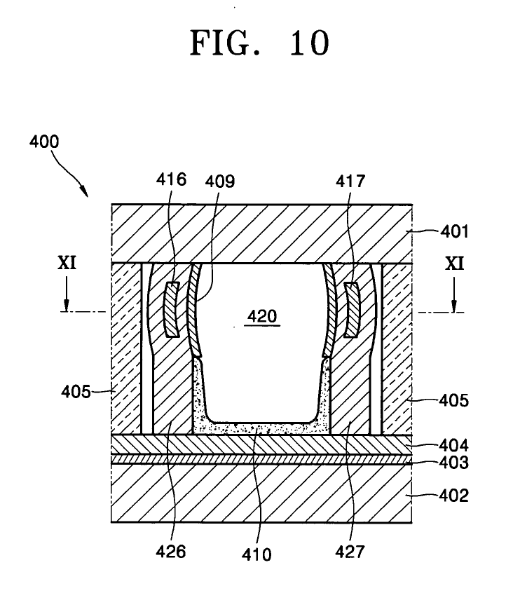

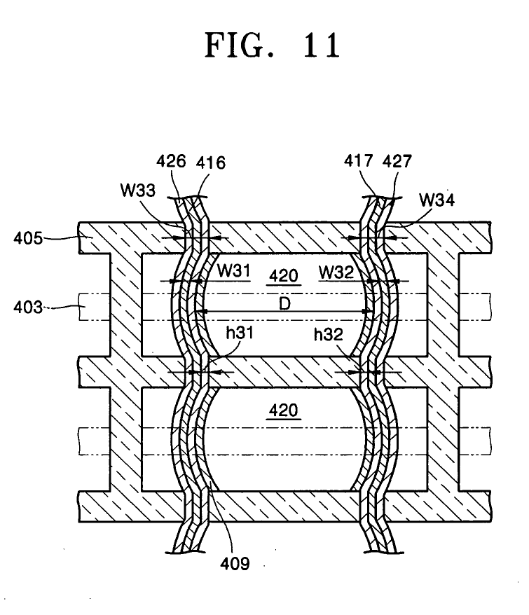

A PDP 400 according to the third exemplary embodiment of the present invention will be described in detail with reference to FIG. 9, FIG. 10 and FIG. 11

The PDP 400 may include a front substrate 401, a back substrate 402, partition walls 405, first and second discharge electrodes 416, 417, address electrodes 403, first and second dielectric layers 426, 427, fluorescent layers 410, and a discharge gas (not shown). Additionally, the PDP 400 may further include a dielectric layer 404 covering the address electrodes 403 and a protective layer 409 covering portions of the first and second dielectric layers 426, 427 in which the first and second discharge electrodes 416, 417 are buried.

The structure and the function of the front substrate 401, the back substrate 402, the address electrodes 403, the fluorescent layers 410, the dielectric layer 404, the partition walls 405, and the protective layer 409 are similar to those of the first embodiment. Hence, the description thereof is omitted.

Referring to FIG. 11, unlike the first and second exemplary embodiments, thicknesses h31, h32 of the first and second dielectric layers 426, 427 covering the first and second discharge electrodes 416, 417 are uniform. Specifically, the first and second discharge electrodes 416, 417, which serve as discharge units making plasma discharge occur in a discharge cell 420, each have substantially uniform widths W31, W32, respectively. Further, the first and second dielectric layers 426, 427 each have substantially uniform widths W33, W34, respectively. Because the third embodiment has a symmetric structure, the width W31 of the first discharge electrodes 416 and the width W32 of the second discharge electrodes 417 opposing each other are the same, and the width W33 of the first dielectric layer 426 and the width W34 of the second dielectric layer 427 opposing each other are the same. However, a distance D between the first dielectric layer 426 and the second dielectric layer 427 is not uniform. Specifically, the distance D between the first dielectric layer 426 and the second dielectric layer 427 is greatest at central portions of the discharge cells 420, and the distance D gradually decreases when moving from the central portions toward the cells' edges.

In the PDP 400 having this structure, because an area of the central portions of the discharge cells 420 may increase and the plasma discharge occurs intensively at these enlarged central portions, the probability that plasma, excited particles, and the like will collide with the partition walls 405 decreases. Further, since the sustain discharge begins where the distance D is small and spreads to a portion of the discharge cell 420 where the distance D is large, the discharge starting voltage may be lowered, but the plasma discharge may still occur vigorously.

In the third exemplary embodiment, the distance D between the first and second dielectric layers 426, 427 is greatest at central portions of the discharge cells 420, but the present invention is not limited thereto because various changes in the distance D may enable control of plasma distribution in the discharge cells. For example, the distance between the first and second dielectric layers 426, 427 may be greatest at edges of the discharge cells 420. In this case, the plasma discharge may intensively occur at edge portions of the discharge cells 420, which may improve luminous efficiency because the fluorescent layers are closer to the edges of the discharge cells 420.

The operation and material characteristics of the first and second discharge electrodes 416, 417 and the first and second dielectric layers 426, 427 are similar to those of the first embodiment, thus the description thereof is omitted.

Additionally, the function of the PDP 400 according to the third exemplary embodiment is similar to that of the first embodiment, thus the description thereof is omitted.

Therefore, according to exemplary embodiments of the present invention, it is possible to manufacture a PDP having a structure that may be capable of controlling plasma distribution in discharge cells.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a front substrate;
a back substrate facing the front substrate;
a plurality of discharge cells between the front substrate and the back substrate;
a first discharge electrode and a second discharge electrode opposing each other in a discharge cell to make a plasma discharge occur in the discharge cell; and
a first dielectric layer covering the first discharge electrode and a second dielectric layer covering the second discharge electrode,
wherein a thickness of the first dielectric layer covering the first discharge electrode is not uniform and a thickness of the second dielectric layer covering the second discharge electrode is not uniform.

2. The PDP of claim 1, wherein each of the first discharge electrode and the second discharge electrode has a uniform width.

3. The PDP of claim 1, wherein each of the first discharge electrode and the second discharge electrode has a non-uniform width.

4. The PDP of claim 1, further comprising a fluorescent layer in the discharge cell and covering a portion of the first dielectric layer and a portion of the second dielectric layer.

5. The PDP of claim 1, further comprising a first protective layer formed at the portion of the first dielectric layer covering the first discharge electrode and a second protective layer formed at the portion of the second dielectric layer covering the second discharge electrode.

6. The PDP of claim 1, further comprising address electrodes extending in a direction to intersect the discharge electrodes.

7. The PDP of claim 6, further comprising a third dielectric layer covering the address electrodes.

8. The PDP of claim 6, further comprising a fluorescent layer in the discharge cells,
wherein the address electrodes are interposed between the back substrate and the fluorescent layer.

9. The PDP of claim 1, wherein the first discharge electrode and the second discharge electrode are arranged to be symmetrical and the first dielectric layer and the second dielectric layer are arranged to be symmetrical in the discharge cells.

10. The PDP of claim 1, further comprising partition walls arranged between the discharge cells to partition the discharge cells.

11. A plasma display panel (PDP), comprising:
a front substrate;
a back substrate facing the front substrate;
a plurality of discharge cells between the front substrate and the back substrate; and
discharge units opposing each other in a discharge cell and for causing a plasma discharge,
wherein a distance between the discharge units is not uniform.

12. The PDP of claim 11, wherein each discharge unit comprises a discharge electrode.

13. The PDP of claim 12, wherein each discharge unit further comprises a dielectric layer covering the discharge electrode.

14. The PDP of claim 13, wherein a distance between the dielectric layer of each discharge unit is not uniform.

15. The PDP of claim 13, further comprising:
a fluorescent layer inside the discharge cells,
wherein the fluorescent layer covers at least a portion of a side surface of the dielectric layer of each discharge unit.

16. The PDP of claim 13, wherein each discharge unit further comprises a protective layer formed at a portion of the dielectric layer covering the discharge electrode.

17. The PDP of claim 12, further comprising an address electrode extending in a direction to intersect the discharge electrodes.

18. The PDP of claim 17, further comprising a dielectric layer covering the address electrode.

19. The PDP of claim 17, further comprising a fluorescent layer in the discharge cells,
wherein the address electrode is interposed between the back substrate and the fluorescent layer.

20. The PDP of claim 11, wherein the discharge units are arranged to be symmetrical.

21. The PDP of claim 11, further comprising partition walls arranged between the discharge cells to partition the discharge cells.
